(19) United States
(12) Patent Application Publication
(10) Pub. No.: US 2014/0272892 A1
(43) Pub. Date: Sep. 18, 2014

(54) ON-LINE CUSTOM COURSE BUILDER

(71) Applicant: EDISON LEARNING INC., Pittsburgh, PA (US)

(72) Inventors: Raymond ROZYCKI, McDonald, PA (US); David ZEILER, Pittsburgh, PA (US); Gabriel ENCK, Pittsburgh, PA (US)

(73) Assignee: EDISON LEARNING INC., Pittsburgh, PA (US)

(21) Appl. No.: 14/199,361

(22) Filed: Mar. 6, 2014

Related U.S. Application Data
(60) Provisional application No. 61/794,365, filed on Mar. 15, 2013.

(51) Int. Cl. G09B 5/08

(52) U.S. Cl. CPC G09B 5/08
USPC 434/350

(57) ABSTRACT

A custom course builder computer application allowing users to search, view, preview, and select e-learning course components based on specific achievement objectives to assemble e-learning custom courses using a repository of content and assessment items. The custom courses may be used for the particular curriculum or may be shared with other schools or institutions.

### CROSS REFERENCE TO RELATED APPLICATIONS

The present application claims benefit to the filing date of Provisional Application No. 61/794,365, filed on Mar. 15, 2013.

### TECHNICAL FIELD OF THE INVENTION

The present invention relates a customize course builder application that allows users to search, view, preview, and select e-learning course components based on specific achievement objectives to assemble e-learning custom courses using a repository of content and test items. Users can then provide custom-built e-learning courses for student enrollment from their user-specific platform of content and test items.

### BACKGROUND OF THE INVENTION

E-learning is an inclusive term that describes educational technology that electronically or technologically supports learning and teaching. E-learning includes numerous types of media that deliver text, audio, images, animation and video through technology applications and processes such as computers, local intranet/extranet and the Internet. E-learning can occur in or out of the classroom. It can be self-paced, asynchronous learning or may be instructor-led, synchronous learning. E-learning is suited to distance learning and flexible learning, but it can also be used in conjunction with face-to-face teaching, in which case the term blended learning is commonly used.

Computer-based learning or training (CBT) refers to self-paced learning activities delivered on a computer or handheld device such as a tablet or smartphone. CBT often presents content in a linear fashion, much like reading an online book or manual. Assessing learning in a CBT is often by assessments that can be easily scored by a computer such as multiple choice questions, drag-and-drop, radio button, simulation or other interactive interface. Assessments are easily scored and recorded via software, providing immediate end-user feedback and completion status. CBTs provide learning stimulus beyond traditional learning methodology from textbook, manual, or classroom-based instruction. For example, CBTs offer user-friendly solutions for satisfying continuing education requirements. Instead of limiting students to attending courses or reading printed manuals, students are able to acquire knowledge and skills through methods that are much more conducive to individual learning preferences. For example, CBTs offer visual learning benefits through animation or video, not typically offered by any other means. CBTs can be a good alternative to printed learning materials since rich media, including videos or animations, can easily be embedded to enhance the learning. CBTs pose some learning challenges. Typically, the creation of effective CBTs requires enormous resources. The software for developing CBTs is often more complex than a subject matter expert or teacher is able to use.

Computer-supported collaborative learning (CSCL) uses instructional methods designed to encourage or require students to work together on learning tasks. Collaborative learning is distinguishable from the traditional approach to instruction in which the instructor is the principal source of knowledge and skills. In contrast to the linear delivery of content, often directly from the instructor's material, CSCL uses blogs, wikis, and cloud-based document portals. With technological Web 2.0 advances, sharing information between multiple people in a network has become much easier and use has increased. Using Web 2.0 social tools in the classroom allows for students and teachers to work collaboratively, discuss ideas, and promote information. After initial instruction on using the tools, students may report an increase in knowledge and comfort level for using CSCL tools. The collaborative tools also prepare students with technology skills necessary in today's workforce.

A learning management system (LMS) is software that may be used for delivering, tracking and managing training and education for CBTs and CSCL; for example, tracking attendance, time on task, and student progress. Educators can post announcements, grade assignments, check on course activity, and participate in class discussions. Students can submit their work, read and respond to discussion questions, and take quizzes. An LMS may allow teachers, administrators, students, and permitted additional parties (such as parents, if appropriate) to track various metrics. LMSs range from systems for managing training/educational records to software for distributing courses over the Internet and offering features for online collaboration.

An LMS has the framework that handles all aspects of the learning process. An LMS is the infrastructure that delivers and manages instructional content, identifies and assesses individual and organizational learning or training goals, tracks the progress towards meeting those goals, and collects and presents data for supervising the learning process of organization as a whole. An LMS delivers content but also handles registering for courses, course administration, skills gap analysis, tracking, and reporting.

Most LMSs are web-based to facilitate access to learning content and administration. They are also used by educational institutions to enhance and support classroom teaching and offering courses to a larger population of learners. LMSs are used by regulated industries (e.g. financial services and biopharma) for compliance training. Student self-service (e.g., self-registration on instructor-led training), training workflow (e.g., user notification, manager approval, wait-list management), the provision of on-line learning (e.g., computer-based training, read & understand), on-line assessment, management of continuous professional education (CPE), collaborative learning (e.g., application sharing, discussion threads), and training resource management (e.g., instructors, facilities, equipment), are all important dimensions of Learning Management Systems.

A learning content management system (LCMS) is software for author content (courses, reusable content objects). An LCMS may be solely dedicated to producing and publishing content that is hosted on an LMS, or it can host the content itself. An LCMS provides a multi-user environment where developers, authors, instructional designers, and subject matter experts may create, store, reuse, manage, and deliver digital e-learning content from a central object repository. LCMS focuses on the development, management and publishing of the content that will typically be delivered via an LMS. Users can both create and re-use e-learning content and reduce duplicated development efforts.

Rather than developing entire courses and adapting them to multiple audiences, an LCMS provides the ability for single course instances to be modified and republished for various audiences maintaining versions and history. The objects stored in the centralized repository can be made available to course developers and content experts throughout an organization for potential reuse and repurpose. This eliminates duplicate development efforts and allows for the rapid assembly of customized content. Some systems have tools to deliver and manage instructor-led synchronous and asynchronous online training based on learning object methodology. LCMSs provide tools for authoring and reusing or re-purposing content (mutated learning objects, or MLOs) as well as for setting up virtual spaces for student interaction (such as discussion forums, live chat rooms and live web-conferences). LCMS technology can either be used in tandem with an LMS, or as a standalone application for learning initiatives that require rapid development and distribution of learning content.

Although LMS and LCMS technologies have been developing, what has been lacking is the ability to generate custom courses from modularized learning content with the flexibility to create courses containing specific standards indicators with customized assessments.

Therefore, it is with respect to these considerations and others that the present invention has been made.

### SUMMARY OF THE INVENTION

The custom course builder allows users to create custom online courses in a short period of time. Users can search, view, preview, and select course components based upon the specific objectives of their district to assemble custom courses easily and efficiently using the repository of content and assessment items. Users may also make their custom built courses available for student enrollment from their user specific platform of content and test items. Key features of the custom course builder are, among other things, searching an existing repository of lesson content, adding lesson content, adding assessment content, creating new assessments from pools of questions, searching and previewing the content before adding to a course, turning on and off lesson components, creating a course, previewing a course, and viewing the summary report upon completing the course. After a custom built course is finalized, the system allows users to make their custom built courses available for student enrollment from their user specific platform of content and test items, or may be published for use at other institutions.

The application incorporates a modular design for course components, so that existing components from other online course(s) can be extracted, re-ordered and combined to create new courses for a content repository. It is designed to aid in search for content based on various meta-tags (such as lesson title and objectives), and most importantly, its alignment with various educational standard sets. The invention is of most interest to school districts, Charter Schools, Online Schools, Private Schools, Blended Learning programs, and teachers wanting a customized online curriculum.

### BRIEF DESCRIPTION OF THE DRAWINGS

The figures are for illustration purposes only. The invention itself, however, may best be understood by reference to the detailed description which follows when taken in conjunction with the accompanying drawings in which:

FIG. 1 shows an example of the modular design of curriculum for the present invention;

FIG. 2 depicts one environment for implementing the custom course builder of the present invention, where the custom course builder application is hosted in a different environment than the LCMS content repository;

FIG. 3 depicts a second environment for implementing the custom course builder of the present invention, where the custom course builder application is hosted in the same environment as the LCMS content respository;

FIG. 4 shows the structure for generating a custom course using the present invention;

FIG. 5 is a flow diagram showing the steps in one embodiment for generating a custom course using the present invention;

FIGS. 6 through 11 show screenshots of one embodiment for selecting lessons in generating a custom course using the present invention;

FIG. 12 shows a screenshot depicting the essential instruction portion of an exemplary lesson;

FIG. 13 shows a screenshot of one lesson in an exemplary custom course;

FIG. 14 is a blow up of the holding bin section of the custom course builder;

FIGS. 15 and 16 are screenshots of the assessment section of the custom course builder of the present invention; and

FIG. 17 shows the summary of an exemplary custom course generated in accordance with the present invention.

### DETAILED DESCRIPTION OF THE INVENTION

Various embodiments will now be described with reference to the accompanying drawings, which form a part of the description, and which show, by way of illustration, specific embodiments. However, this invention may be embodied in many different forms and should not be construed as limited to the specific embodiments set forth herein. Rather, these embodiments are provided so that this disclosure will be thorough and complete, and will fully convey the scope of the invention to those skilled in the art. As described below, various embodiments of the invention may be readily combined without departing from the scope or spirit of the invention.

Using the custom course builder educational institutions, including schools, universities and businesses (collectively, “schools”), have the ability to create a dynamic curriculum matched to their scope and sequence. Schools can build courses used to support any traditional school environment, blended learning environment, or a purely online program. The custom course builder of the present invention allows for the creation of custom online coursework using a repository of lessons and resources. As used herein, a “course” is the same as a class and is considered to be a series of related educational materials in a progressive order designed to teach a student about a particular subject matter. A “modularized learning object” is a particular topic or piece of educational material that typically is self-contained, but may also build on other topics. Modularized learning objects typically will consist of an objective, a standard and an assessment. Modularized learning objects may be synonymous with the terms “lesson”, “module” or “exercise.” An “assessment” may be a quiz, exam or test that is used to evaluate the knowledge of the student about the particular lesson.

There are several actors involved in the custom course builder as follows:

Custom course builder user (“user”): uses the custom course builder application to select and assemble pre-built course components for the purposes of creating new custom courses. This could be a teacher or other course developer.

Content developer: creates the modular content components, and identifies which items are available to the custom course builder.

Gatekeeper: reviews, tags and makes the created course content available for the custom course builder. The gatekeeper is typically responsible for the integrity of the content of the repository.

Custom course approver: responsible for reviewing those courses built by the custom course builders. This could be a school district's director of curriculum or similar type position.

In alternate embodiments, any of the actors could be combined, or in some instances eliminated. Thus, for example, the content developer, gatekeeper, custom course builder, and custom course approver could be the same actor. In another instance, the gatekeeper and custom course approver roles could be eliminated.

The invention may be typically implemented through software running on a computer. The computer may be any type of client device, including desktop computers, laptop computers, tablet computers, cell phones and any other device. The computer may be capable of establishing a communications link with the Internet, local area network or a wide area network through either a wired medium or wireless medium, and the computer may run an application program enabling the device to perform the programmed algorithms. The application for performing the algorithms of the invention as described below may be implemented on a standalone computer, or maybe implemented through several computers connected via a network. In one embodiment, the algorithms of the invention may be implemented on a central server, where the students access the system through remotely located client devices. The application programs are stored in physical memory devices, such as RAM, ROM, hard-drives, optical drives and any other non-volatile memory device. The client devices may include application programs that send and receive web-pages, web-based messages, and data packets having content for updating the program and display of the client devices. The client devices may have operating systems that enable the application programs.

The general implementation of the concept of a modular design for curriculum is shown in FIG. 1. In each content area 102 such as, for example, mathematics, there are subjects 104 (e.g., Algebra) and, then within subjects 104 there are sets of standards 106. Standards 106 are written expectations for meeting a specified level of performance, and are adopted by state agencies 107 responsible for the approval of curricular programs. An important piece to the design of modular course content is that each component is mapped to a specific standard indicator 108. This is used for determining the educational value of a component when searching in the repository for lessons 111 that cover a certain educational topic. Along with standards, lessons have learning objectives 109 tagged to them, which explain what the student should be able to understand when they have completed the lesson.

A bundle is a set of lessons that are grouped together due to them having related flow of content. For example, if Lesson 1 covers Chapter 1 of a book, Lesson 2 covers Chapter 2 of the same book, and Lesson 3 covers Chapter 3 of that book, then those 3 lessons could be placed into a bundle together to discourage the custom course builder from breaking them apart.

Each lesson may consist of several types of components. Essential instruction 110 covers all the ideas of the objectives/standards. Reteaching 112 is used for re-teaching the main ideas of the objectives/standards and frequently contains practice questions. Enrichment or extension 114 extends and expands on the main ideas of the objectives/standards. Assessment 116 assesses the student's understanding of the objectives/standards.

One embodiment of an implementation of the custom course builder is shown in FIG. 2. Repository server 202 contains a repository 204 of learning objects. Repository 204 is accessed by course builder 206 that is located on client platform server 208. The access by repository 204 may be either through the Internet, LAN/WAN, or similar network systems. Course assembler 210 uses course builder 206 to create custom course 212 from the repository components. Custom course 212 may reside on client platform server 208. Users are allowed to enroll in custom course 212, but the custom course is not available to other schools or institutions. That is, custom course 212 is only available to the school that created it. The content for custom course 212 may reside on repository 204 and be downloaded on an as needed basis, or the content may be transferred and reside on client platform server 208.

A second embodiment of the custom course builder is shown in FIG. 3. In this embodiment, custom course builder server 302 contains repository 304 as well as hosts course builder 306. The user may create custom course 312 through course assembler 310 that uses course builder 306. Course assembler 310 may reside on the client's platform server or may reside on custom course builder server 302. When the custom course 312 is published, it will be placed in the repository thereby making the custom course available for any school that has permission to use it. Thus, the custom course may be created by one school, such as school 314, and the custom course can be used by a second school, such as school 316. The various components may reside on one computer or multiple computers at one location or at multiple locations.

A general diagram for creating a custom course is shown in FIG. 4. Repository 404 contains a plurality of learning objects 418. Course builder 406 provides a repository search tool for a user to search the repository for appropriate learning objects to create custom learning courses 420. Custom learning course 420 may consist of any number of learning objects 418 placed in any order selected by the user. Certain of learning objects 418 may be bundled as shown in FIG. 4 by learning objects three and four. In this instance, learning object three is a prerequisite to learning object four, and course builder 406 is discouraged from breaking them apart. Any number of custom learning courses may be created within course builder 406. These custom courses may be accessed by only the school that created the particular custom learning course or, if made available to others, maybe be accessible by other schools.

The process for creating a custom course is shown in FIG. 5. A user will view a display of the contents of the repository as shown in block 502. In block 504, the repository may be searched for modularized electronic learning objects using search criteria. The search criteria may be through keywords, topical indexing, meta-tags, metadata and any other method of organizing learning objects such that they can be searched. The user selects the individual modularized electronic learning objects to be included in the custom course in block 506. When the selection is complete, the user may organize or reorder the selected modularized electronic learning objects, as shown by blocks 506 through 512. Once the selection and reordering are complete, electronic learning objects are bundled into an electronic learning course in block 514 and then stored as an electronic learning course in block 516. At this point, the custom learning course is available for use.

A more specific description of the use of the custom course builder is shown in FIGS. 6 through 17. This description is exemplary only, and any number of other implementations and variations may be used to carry out the invention.

The custom course builder may require access credentials to use, and may be accessed either locally or remotely. On entry into the system, a window depicting control panel 602 is shown to the user. The custom course builder may be accessed by selecting icon 604. From this control panel, the user may also choose to create or manage custom courses by selection of icon 606, access messages sent through the system through icon 608 or send messages to other users of the system through icon 610. After clicking on icon 604, custom course screen 702 shown in FIG. 7 may show any existing custom courses that are in the process of creation.

Each course may show name 704 of the custom course, unique code 706 identifying the course, included forums 708 that lists the forums that will be created for the course once it is published, enabled intervention 710 that lists whether the course will have interventions turned on or not once the custom course is published, details 712 used to access the custom course builder page and make changes to the custom course, edit 714 is used to edit the custom course worksheet settings on the current screen, and delete 716 which deletes the custom course worksheet from the system. Custom course screen 702 may alternatively also show the set of standards displayed when searching for specific content.

The initial setup for creating any custom course may be initiated from the custom course screen by clicking create button 718. This may then direct the user to the screen shown in FIG. 8.

The user may complete all of the empty fields on the screen which includes many of the same fields as shown in FIG. 8: name 704 of the course, unique identifier code 706, school platform 707 where the course will be used, state standards 709 the used in the course, the location where the course is stored, enabling 710 of interventions, whether or not the system should automatically create a forum for each unit and lesson for the course on being published as shown by callout 708. The information may be entered in any fashion for example through drop-down menus, data entry, check boxes, or any other known methods. The fields and settings set on this screen may be changed after the course is published.

On completing the setup process, the user is directed to the created custom course as shown in FIG. 9. This is where the user will find the tools needed to search for and select the learning objects to include in the custom course. Learning objects range from pages of objective-based content to video files to enrichment material to assessment items.

Window 902 shows course learning package 904 and holding bin 906. Course learning package 904 is where the user can create units and place lessons into for including in the custom course. Holding bin 906 is a work area where the user temporarily places lessons that are found while searching. Holding bin 906 may be considered as a way to bookmark one or more lessons that they may be interested in adding to the course but are not completely certain that the lessons should be included in the course or where to add them yet. The user may move the lessons into the correct place in the learning package. When the custom course is created, anything in holding bin 906 is cleared and does not become part of the custom course.

Progress field 910 and progress bar 912 may be displayed in window 908. Progress field 910 show how many lessons have been placed into the learning package and progress bar 912 shows the percentage completion of the course. The percentage is based on a 45 lesson course, which in one embodiment is the maximum number of lessons for any custom course. In this embodiment, the user will not be able to place more than 45 lessons into the course learning package of the custom course worksheet.

To add lessons, the user clicks add button 914, which pulls up repository search tool 1002, shown in FIG. 10. There may be several ways to search for content to add to the custom course. Keywords may be entered, which will find lessons, units, or even entire courses based upon the search parameters. The search may also be refined by filtering using the advanced search options 1004 to search within the lesson title, lesson objectives, standard, or skill. The user may refine the list of course content by selecting a specific standard from a list generated through the selection of a content area. Further, the user may refine the list of course content by searching for a specific skill by selecting from a list generated through the selection of a standard. By using possible keywords that relate to the course, the user will be able to come up with lists of content that can be included in the course. The user may then click go button 1006 to view the results. To clear the search settings, the user may click reset button 1008.

The search results may appear as shown in FIG. 11, which provides a list of lessons that match the search criteria. The returned list of lessons may contain lesson title 1102, objectives 1104 and origination location 1108. The user may preview the lesson content by clicking on preview icon 1110. The lesson will be shown as it appears to the students. The user may add a lesson to the custom course by selecting one or more lessons from the list. This is done by marking the checkbox next to the lesson title, and then clicking add to course button 1112 to add it to the course of learning package 904 or by clicking add holding bin button 1114 which adds the lesson to holding bin 906.

In one embodiment, each lesson may contain three pages of content and one or more assessments, as shown for example in FIG. 12. The first page is viewed by clicking on icon 1202. This shows essential instruction in the adjacent window pane and shows the core material covering the objectives, as shown by example in FIG. 12. Second page 1204 shows re-teaching, which summarizes the lesson and provides the student an activity and answers. Third page 1206 shows enrichment, giving the student supplemental material and web links to reinforce their understanding of the content. Fourth page 1208 contains access to the assessments.

In the toolbar along the top of the screen, each lesson has icons for various materials, including instructional video 1210, a need to know animation 1214, textbook module 1216 with exercises, as well as answer key 1218 for those exercises. The exemplary math lesson shown also includes calculator 1212, and all lessons have a notepad tool 1220 that is available to students.

After selection of lessons to include in the course, the user may then move any courses placed in holding bin 906 to actual units in the learning package. By clicking the arrow to its left will expand the holding bin, which displays three default units, as shown in FIGS. 13 and 14. The lessons from the search list will be dropped into these unit folders. A unit's arrow may be selected to view the lessons inside. These lessons can be moved to different unit folders in the holding bin or into the course itself.

To add a new unit folder, select the course learning package in which the unit should be create, then select create button 1402 and select the unit from the pop-up menu (not shown). In one embodiment, custom courses can have no more than 45 lessons, but these lessons can be organized into any number of unit folders.

By holding the left mouse button after selecting the lesson in the holding bin, the user may drag and drop the lesson into a unit folder or be re-ordered in the course learning package. Any lesson may be changed at any time in the course learning package by dragging and dropping into a preferred location.

A summary of the lesson may be shown in window pane 1302 in FIG. 13. The user may modify additional unit parameters by clicking pencil icon 1304 to edit any of the fields. The user may edit the lesson's name and title, as well as turning on/off the essential instruction, re-teaching, extension, and assessment components of the lesson. Toolbar items can also be used or disabled from your custom course. The user may click magnifying glass icon 1306 to preview the unit or may click trash can icon 1308 to delete the unit.

By clicking on a lesson, the user may see all of its learning objects and some configurable options. Origination field 1310 shows the course(s) and unit(s) the lesson came from within the content repository.

As a lesson is added, the lesson may automatically link any assessment that comes with it by default. In FIG. 15, the user may view the assessment structure, point values and questions themselves by expanding a lesson and clicking the assessment inside. The user may modify the assessment by using additional tools, but in one embodiment the actual content of the assessment items cannot be modified.

Each lesson has associated question banks. A user may add questions from another unit or lesson into a new assessment in the custom course. This may be done through a select lessons screen shown in FIG. 16 or other suitable method. The user can enter a point value for the questions. The user may also create custom assessments such as lesson or unit exams. Unit exams are an excellent way to add cumulative assessments to the custom course.

Once the user has added all of the lessons and created any assessments to include in the course, the user will be able to click preview course to see what the course is like. The user may then click the create course button. Custom Course Summary screen 1702 will be displayed. This screen gives a summary of the course including learning objectives, lesson objectives, and original location of lesson.

By expanding each lesson, the user will be able to view more details that include the subject, content area, standard, and skill. At this point, the course is still able to be edited and reorganized. When finished reviewing this information, the user may click the finish button at the bottom of the screen to access the publication tool that will cause the course to be published. The course may be subject to review and approval by a custom course approver or may now be available for student enrollment in the user's system.

The course may be made available to other schools or institutions. Also, the course and/or any additional materials created for the custom course may be added to the repository, including lessons, bundles and custom assessments. To maintain the integrity of the courses and repository, the addition of such materials may be subject to the approval of gatekeepers. The gatekeeper may be selected individuals or may be a community of persons. The review of materials may be assigned or the responsibility of select gatekeepers, or the materials may be subject to ratings by the users of the system, that is, the custom course builder users, which are then used to determine whether to allow access to the additional materials. The gatekeeper community may have a separate password protected access to the course builder system tailored for the functions performed by the gatekeeper community.

Any lesson content or components could be changed, as long as they are appropriately tagged with searchable meta-data, such as title, objectives, or standard skill/indicators.

The custom course builder application is not functionally limited to educational materials (although its design is tailored to it) and could be used to search out and re-assemble any kind of web-based text, audio, videos, images, or other interactive multimedia from its associated content repository and bind those components together into a hierarchal collection. For example, a “custom course” could be created out of web comics or music videos.

Although other modifications and changes may be suggested by those skilled in the art, it is the intention of the inventors to embody within the patent warranted hereon all changes and modifications that reasonably and properly come within the scope of their contribution to the art.

What is claimed is:

1. A system for generating a customized electronic learning course comprising:
a server having non-volatile memory containing modularized electronic learning objects, where each learning object relates to a subject, has a specific standard indicator and has an associated assessment;
a network device having a display that is in communication with the server and in conjunction with the server has computer executable instructions stored in memory that may be performed by a processor that enable steps including:
displaying a subset of the modularized electronic learning objects based on search criteria entered by a user;
selecting individual modularized electronic learning objects for inclusion into either a holding bin for later insertion into a course learning package or directly into the course learning package;
inserting modularized electronic learning objects into the course learning package;
re-ordering the modularized electronic learning objects within the course learning package;
publishing the course learning package as a customized electronic learning course; and
storing the customized electronic learning course.

2. The system of claim 1, where the network device has further executable instructions that enable steps including:
calculating a total specific standard indicator; and
displaying the total specific standard indicator on a monitor prior to publishing the course learning package.

3. The system of claim 1, where the network device has further executable instructions that enable steps including:
determining progress towards a total number of modularized electronic learning objects for the course learning package; and
displaying a progress bar to the user.

4. The system of claim 1, wherein the search criteria are queried against a lesson title, lesson objectives, lesson standards, lesson standard indicators or lesson skills for the modularized electronic learning objects of the repository.

5. The system of claim 1, where the network device has further executable instructions that enable steps including:
selecting assessments for the course learning package.

6. The system of claim 5, wherein the network device has further executable instructions that enable steps including:
generating assessments including new assessments or cumulative assessments.

7. The system of claim 1, the network device having further executable instructions that enable steps including:
generating a summary report for the complete course learning package prior to publication.

8. The system of claim 1, wherein each modularized electronic learning object contains essential instruction, re-teaching, enrichment and assessment.

9. The system of claim 1, wherein the customized electronic learning course is stored within the repository and is available to other users of the system that are not associated with the user.

10. The system of claim one, network device having further executable instructions that enable steps including:
publishing the course learning package as the customized electronic learning course only after receiving gatekeeper approval.

11. A method of generating a custom electronic learning course comprising:
transmitting through a computer network a subset of modularized electronic learning objects from a repository for display on a monitor of a computer, where the subset is generated by a query using keyword searches of a lesson title, lesson objectives, lesson standards, lesson standard indicators or lesson skills for the modularized electronic learning objects in the repository;
receiving through the computer network selection of the individual modularized electronic learning objects from a user for inclusion into either a holding bin for later insertion into a course learning package or directly into the course learning package;
inserting modularized electronic learning objects into the course learning package based on receipt of the selection of the individual modularized electronic learning objects;
changing the hierarchal structure of the modularized electronic learning objects within the course learning package at an election of the user;
publishing the course learning package as a customized electronic learning course; and
storing the customized electronic learning course in non-transient memory.

12. The method of claim 11 further comprising:
calculating a total specific standard indicator; and
displaying the total specific standard indicator on a monitor prior to bundling of the modularized electronic learning objects into the custom electronic learning course.

13. The method of claim 11 further comprising:
generating an aggregated specific standard indicator for the user selected modularized electronic learning content;
determining the educational value of the custom course based on the aggregated specific standard indicator.

14. The method of claim 11 further comprising:
determining progress towards a total number of modularized electronic learning objects for the course learning package; and
displaying a progress bar to the user.

15. The method of claim 11 further comprising:
generating assessments including new assessments or cumulative assessments.

16. An apparatus for generating a customized electronic learning course comprising:
a memory storing a repository of modularized electronic learning objects that have subjects, specific standard indicators and assessments;
a repository search tool capable of displaying on a computer screen a subset of the repository of modularized electronic learning objects based on search criteria entered by a user;
an electronic holding bin for temporarily holding selected modularized electronic learning objects;
a course learning package that contains the selected modularized electronic learning objects that will form the customized electronic learning course, where modularized electronic learning objects may be moved from the holding bin to the course learning package and the electronic learning objects may be re-ordered by a user; and
a publication tool that finalizes and stores the course learning package as the customized electronic learning package.

17. The apparatus of claim 16, wherein the customized electronic learning package is stored within the repository.

18. The apparatus of claim 16, further comprising:
a progress bar indicator that shows a total number of modularized electronic learning objects for the course learning package.

19. The apparatus of claim 16, further comprising:
a total specific standard indicator that shows the total educational value of the course learning package.

20. The apparatus of claim 16, further comprising:
a custom assessment tool for creating or modifying assessments.
